(19) United States
(12) Patent Application Publication
(10) Pub. No.: US 2017/0229777 A1
(43) Pub. Date: Aug. 10, 2017

(54) ANTENNA STRUCTURE AND ANTENNA APPARATUS

(71) Applicant: SAMSUNG ELECTRO-MECHANICS CO., LTD., Suwon-si (KR)

(72) Inventors: Jong Lae KIM, Suwon-si (KR); Ho Jin LEE, Suwon-si (KR); Dae Seong JEON, Suwon-si (KR); Ju Hyoung PARK, Suwon-si (KR); Jeong Ki RYOO, Suwon-si (KR)

(21) Appl. No.: 15/243,230

(22) Filed: Aug. 22, 2016

(30) Foreign Application Priority Data
Feb. 4, 2016 (KR) 10-2016-0014139

(51) Int. Cl. H01Q 7/06; H04B 5/00; H01Q 1/24

(52) U.S. Cl. CPC H01Q 7/06; H01Q 1/243; H04B 5/0031

(57) ABSTRACT

An antenna apparatus includes an antenna structure and an integrated circuit (IC). The antenna structure includes a magnetic core extended in one direction, a conductive wire wound around the magnetic core to form a coil, and a magnetic material surrounding the conductive wire in a portion of the coil. The IC supplies an electrical current to the coil. In addition, a portion of magnetic flux generated by flow of the electrical current supplied to the coil exits from one end surface of the magnetic core and enters another end surface of the magnetic core opposite to the one end surface in the one direction. Another portion of the magnetic flux flows through the magnetic material surrounding the conductive wire.

### CROSS-REFERENCE TO RELATED APPLICATION

This application claims the priority and benefit of Korean Patent Application No. 10-2016-0014139 filed on Feb. 4, 2016, with the Korean Intellectual Property Office, the disclosure of which is incorporated herein by reference.

### BACKGROUND

1. Field

The present disclosure relates to an antenna structure and an antenna apparatus.

2. Description of Related Art

As the field of mobile communications continues to develop, new antenna technologies for high-speed data and mass information transmission are being developed to support the needs of users including the real-time streaming of video.

At the same time, near field communication (NFC) technology is increasingly being used in portable terminals, such as smartphones, portable multimedia players (PMPs), navigation devices, or the like, the provide the portable terminals with services such as data exchange, personal authentication, payments, and the like.

In general, an antenna having a loop pattern is formed in the interior of a battery compartment or within the cover of a portable terminal to allow for NFC-based communication. Such an antenna having a loop pattern requires a large area in order to increase radiation efficiency. However, the available space in portable terminals is limited as the terminals are formed to be increasingly small and slim.

### SUMMARY

An aspect of the present disclosure may provide an antenna structure and an antenna apparatus, configured to have a chip shape, thus being miniaturized.

According to an aspect of the present disclosure, an antenna structure may include a magnetic core, a coil wound around the magnetic core, and a magnetic material surrounding a conductive wire in a portion of the coil. In this way, a portion of magnetic flux generated by flow of an electrical current supplied to a coil may exit from one side of the magnetic core and may enter another side thereof opposite to the one side. Another portion of the magnetic flux may flow through the magnetic material surrounding the conductive wire in the portion of the coil.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a schematic perspective view illustrating an electronic apparatus according to an embodiment;

FIG. 2 is a circuit diagram of an antenna apparatus according to an embodiment;

FIG. 3A is a schematic diagram illustrating magnetic flux generated by an antenna apparatus according to an embodiment;

FIG. 3B is a schematic diagram illustrating magnetic flux generated by an antenna apparatus according to another embodiment;

FIGS. 4A and 4B are perspective and side views of an antenna structure according to an embodiment;

FIGS. 5A and 5B are perspective and side views of modified embodiments of an antenna structure;

FIGS. 6A and 6B are perspective and side views of an antenna structure according to another embodiment;

FIGS. 7A and 7B are perspective and side views of a modified embodiment of an antenna structure; and

FIGS. 8A and 8B are perspective and side views of an antenna structure according to a further embodiment.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

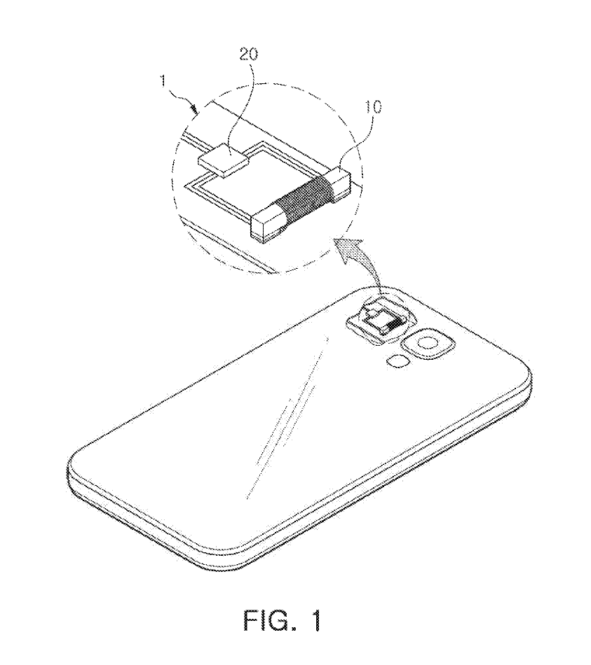

FIG. 1 is a schematic perspective view illustrating an electronic apparatus according to an embodiment.

An electronic apparatus according to the embodiment of FIG. 1 may include various devices, such as a mobile phone, a personal digital assistant (PDA), a digital camera, or the like, and may not be limited thereto. The electronic apparatus is a device that is equipped for near field communication (NFC).

With reference to FIG. 1, the electronic apparatus according to the embodiment may include an antenna apparatus.

The antenna apparatus 1 may include an antenna structure 10 including a chip antenna formed in such a manner that a coil is wound around a magnetic core, and may include an integrated circuit (IC) 20 supplying an electrical current to the antenna structure 10. The antenna apparatus 1 may be configured for short-distance wireless communications, such as NFC, magnetic secure transmission (MST), wireless power transfer (WPT), radio frequency identification (RFID), or the like.

The antenna apparatus 1 may be disposed in or near an edge or corner of an outer surface of a case of the electronic apparatus, in order to implement effective short-distance wireless communications. For example, in order to transmit magnetic flux generated in the chip antenna to an external communications device, the antenna structure 10 may be disposed in such a manner that a virtual extension of the antenna structure 10 (e.g., a virtual extension in the direction of a length of the magnetic core of the chip antenna) intersects with an end of the electronic apparatus in a length direction thereof (e.g., an edge of the electronic apparatus in the length direction, where the electronic apparatus has a length longer than its width).

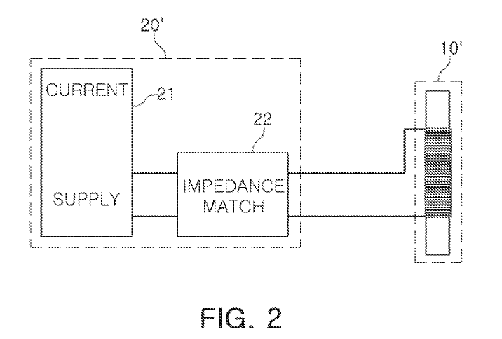

FIG. 2 is a circuit diagram of an antenna apparatus according to an embodiment in the present disclosure.

With reference to FIG. 2, an antenna apparatus 1 according to an embodiment may include an antenna portion 10′ and an antenna control portion 20′. The antenna portion 10′ and the antenna control portion 20′, as illustrated in FIG. 2, may be provided as components respectively corresponding to the antenna structure 10 and the IC 20 illustrated in FIG. 1.

With reference to FIG. 2, the antenna control portion 20′ may include a current supply portion 21 and an impedance matching portion 22. The current supply portion 21 may supply an electrical current to both ends of the antenna portion 10′. In the meantime, the impedance matching portion 22 may match impedance between the current supply portion 21 and the antenna portion 10′, thus reducing loss of the electrical current supplied to the antenna portion 10′.

As a result of the electrical current being supplied by the current supply portion 21 to the antenna portion 10′, magnetic flux may be formed in the antenna portion 10′. Furthermore, through transfer of the magnetic flux to an external device, short-distance wireless communication of information may be provided through the antenna portion 10′.

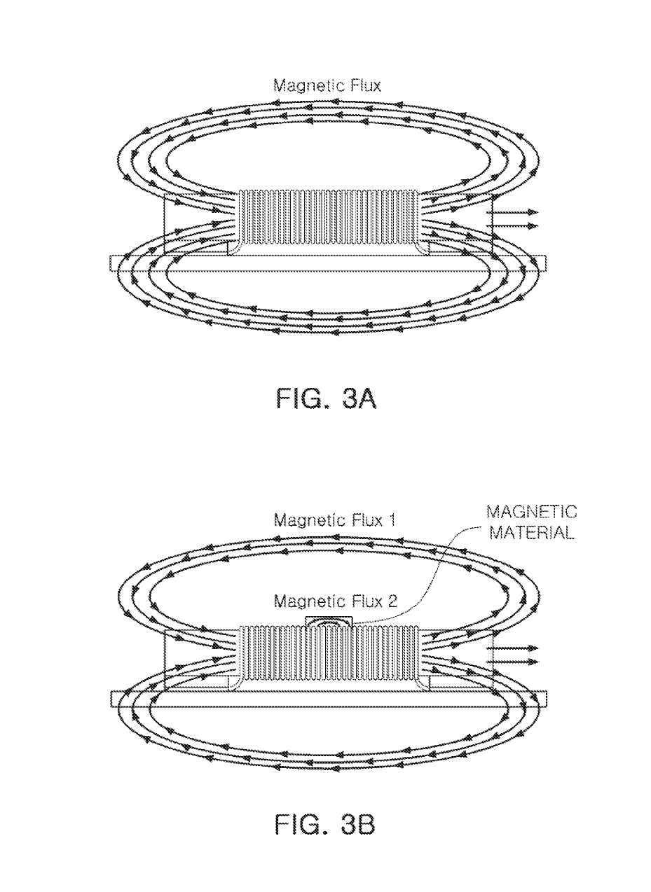

FIG. 3A is a schematic diagram illustrating magnetic flux generated by an antenna apparatus according to an embodiment.

As described above, the magnetic flux may be generated through current supply to the antenna apparatus. As a radiation range of the magnetic flux becomes relatively wide, and an inductance value becomes relatively high, communications with an external device may be effectively implemented.

As illustrated in FIG. 3A, the magnetic flux may enter and exit through a magnetic core to be radiated externally. The magnetic flux may be transmitted to the external device disposed external to the antenna apparatus. In addition, due to a difference in permeability of external air and of the magnetic core, the value of the magnetic flux drops off and is lower at further distances from the magnetic core. Therefore, long-distance wireless communications may not be effectively implemented due to the drop-off in the value of the magnetic flux at large distances from the antenna apparatus.

In order to increase the value of the magnetic flux in the external region, the permeability of the magnetic core may be increased. However, the value of the magnetic flux in the external region may not be increased by as much as the permeability of the magnetic core may be increased. In addition, an entirety of a surface of a coil wound around the magnetic core may be covered with a magnetic material so as to seal or encase the coil wound around the magnetic core, thus increasing the value of the magnetic flux. However, there may be a problem in which the radiation range of the magnetic flux is reduced.

FIG. 3B is a view illustrating magnetic flux generated by an antenna apparatus according to an embodiment in the present disclosure.

With reference to FIG. 3B, a magnetic material may be formed to surround a conductive wire in a portion of a coil region. Specifically, while the coil has an inner surface facing the magnetic core, the magnetic material may be disposed on a portion of an outer surface of the coil facing away from the magnetic core such that the portion of the coil having the magnetic material thereon is surrounded by the magnetic core on one side and the magnetic material on the other sides. Due to a difference in permeability of an external region and of the magnetic material, a path may be formed in such a manner that a portion of the magnetic flux, magnetic flux 1, may exit from one end of a magnetic core to enter the other end thereof after moving through an external medium, such as air. Magnetic flux 1 thus follows an open-loop path through air. On the other hand, a path of another portion of the magnetic flux, magnetic flux 2, may be formed within the magnetic material with the magnetic flux 2 not exiting from and entering one and the other end of the magnetic core. Magnetic flux 2 thus follows a closed-loop path through the magnetic material and the magnetic core.

In other words, due to the presence of the magnetic material near the coil region, the magnetic flux 2 may not be radiated outwardly, and an entirety of the path may be formed through the magnetic material. In this case, although the magnetic flux 2 is not being radiated outwardly due to the presence of the magnetic material, a value of the total magnetic flux may be increased relative to an embodiment in which the magnetic material is not present.

According to an illustrative embodiment, the magnetic material may be formed to surround the conductive wire in the portion of the coil to increase the value of magnetic flux radiated externally without a loss of radiation range thereof.

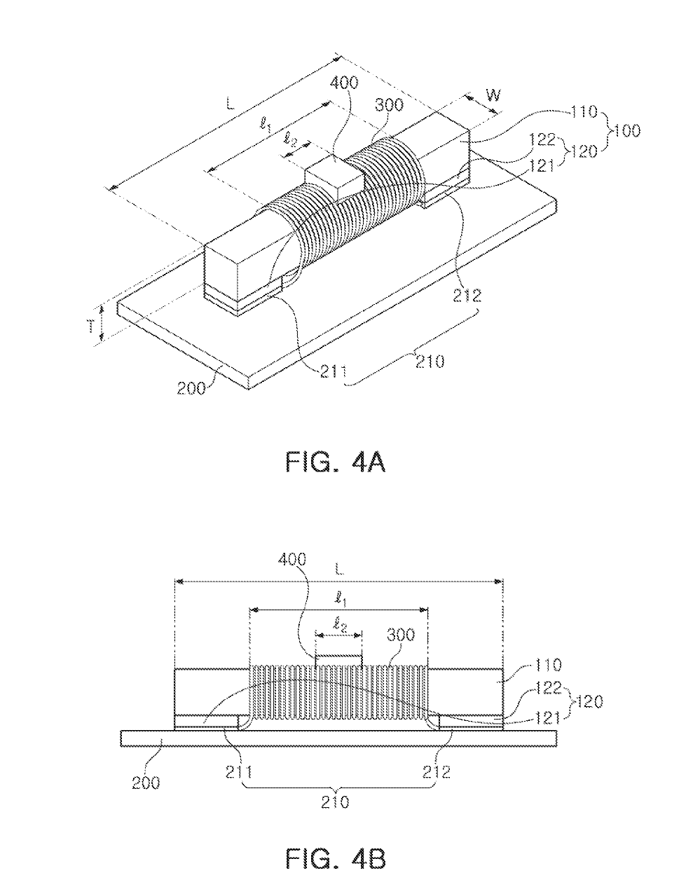

FIGS. 4A and 4B are perspective and side views of an antenna structure according to an embodiment.

With reference to FIGS. 4A and 4B, an antenna structure according to an embodiment in the present disclosure may include a core member 100, a circuit board 200, a coil 300, and a magnetic block 400.

The core member 100 may include a magnetic core 110 and a support member 120.

The coil 300 may be wound around an outer circumferential surface of the magnetic core 110. In addition, in order to provide a path for the exit and entry of magnetic flux generated by an electrical current flowing through the coil 300, the magnetic core 110 may include a magnetic material having high permeability. The magnetic core 110 may be formed in such a manner that a material having a predetermined dielectric constant and permeability may be mixed with a composite material, such as ceramics, or the like, and may be sintered.

The magnetic core 110 may be formed to have a hexahedral form, a cylindrical form, or other various form. In the case that the magnetic core 110 is formed to have a hexahedral form, the magnetic core 110 may have a length L in a first direction, a width W in a second direction, and a thickness T in a third direction thereof. The magnetic core 110 may have four main surfaces extending in a length direction (the first direction) thereof and two end surfaces in both end portions thereof in the length direction. The magnetic flux may exit from one of the two end surfaces of the magnetic core 110 to enter the other thereof.

The magnetic core 110 may be mounted on the circuit board 200 through the support member 120. The support member 120 may support the magnetic core 110 so that the magnetic core 110 may be mounted on the circuit board 200 and spaced apart from the circuit board 200.

The support member 120 may include first and second support members 121 and 122. First surfaces of the first and second support members 121 and 122 may be attached to both end portions of the magnetic core 110 in the length direction thereof. In addition, second surfaces of the first and second support members 121 and 122 (each second surface being opposite to the first surface) may be attached to first and second pads 211 and 212 disposed on the circuit board 200.

The magnetic core 110 may be disposed to be spaced apart from the circuit board 200 by a height equal to a sum of the heights of the first support member 121 and the first pad 211 or to a sum of the heights of the second support member 122 and the second pad 212. Accordingly, in the case that the coil 300 is wound around the magnetic core 110, sufficient space may be provided between the magnetic core 110 and the circuit board 200 for the coil 300 to be wound more easily.

However, positions of the first and second support members 121 and 122 may not be limited to those shown in FIGS. 4A and 4B. Furthermore, if the magnetic core 110 is mounted on the circuit board 200, the positions of the first and second support members 121 and 122 may change, and the number of support members may also change.

The circuit board 200 may be provided as a printed circuit board (PCB) mounted within an electronic apparatus. The first and second pads 211 and 212 may be attached to a surface of the circuit board 200. Although not illustrated in detail, an integrated circuit (IC) used for short-distance wireless communications may be disposed on a side of the circuit board 200. The IC may be electrically connected to the first and second pads 211 and 212 through a circuit pattern disposed in the circuit board 200. The IC may supply an electrical current to the coil 300 wound around the magnetic core 110 through the first and second pads 211 and 212.

The coil 300 may be wound around the magnetic core 110. In addition, when the electrical current flows through the coil 300, the magnetic flux exiting from and entering both end surfaces of the magnetic core 110 in the length direction thereof may be formed.

The coil 300 may be provided as a covered conductive wire that is coated with an insulator in such a manner that a polyurethane resin, a polyester resin, or the like, may cover an outer circumferential surface of a metal wire formed of copper (Cu), silver (Ag), or the like.

The coil 300 may be formed or disposed to be wound around an outer circumferential surface of the magnetic core 110. The coil 300 may be wound around the magnetic core 110 such that the coil has a circular cross section, and/or may be wound around the magnetic core 110 to conform to a cross-sectional shape of the core, such as a quadrangular shape. The metal wire of the coil 300 may have a cross-sectional shape of a circle, or may have a cross-sectional shape of a polygon.

The magnetic block 400 may be formed of a magnetic core material and disposed to surround the conductive wire in a portion of the coil 300.

The magnetic block 400 may be formed in such a manner that after the winding of the coil 300 on the magnetic core 110, the material for forming the magnetic block 400 and having a predetermined dielectric constant and permeability is mixed with a composite material, such as ceramics, or the like, and is sintered. For example, the magnetic block 400 may include the same material as the magnetic core 110.

The magnetic block 400 may provide a closed path for a portion of the magnetic flux exiting from and entering the magnetic core 110. In the case that the magnetic block 400 is formed to surround the conductive wire in the portion of the coil 300, thus surrounding the conductive wire therein, a portion of the magnetic flux formed in the length direction of the magnetic core 110 may not exit from and enter the end surfaces of the magnetic core 110 in the length direction thereof, but may instead follow a path through the magnetic block 400.

The magnetic block 400 may be formed or disposed on the magnetic core 110 to surround the conductive wire in the portion of the coil 300 in the length direction thereof. Specifically, while the coil formed of the conductive wire has an inner surface facing the magnetic core 110, the magnetic block 400 may be disposed on a portion of an outer surface of the coil facing away from the magnetic core, such that the portion of the coil having the magnetic block 400 thereon is surrounded by or disposed between the magnetic core 110 on one side and the magnetic block 400 on the other side (s). In detail, the magnetic block 400 may be formed in a portion of a region among regions of the magnetic core 100 wound in a length direction of the coil 300.

With reference to FIGS. 4A and 4B, the magnetic block 400 may be formed on the magnetic core 100 to cover a region corresponding to a length l2 corresponding to a portion of a total length l1 of the coil 300 (e.g., l2<l1). The magnetic block 400 may be formed on the magnetic core 100 to have a hexahedral form, and may also be formed to have a different form, such as a semicircular form, or the like, to cover the coil 300 wound around the magnetic core 100.

In FIGS. 4A and 4B, one magnetic block 400 is illustrated, but the magnetic block 400 may be provided as a plurality of magnetic blocks. Each of the plurality of magnetic blocks may be formed to surround the conductive wire in a plurality of regions not overlapping each other in the length direction of the coil 300.

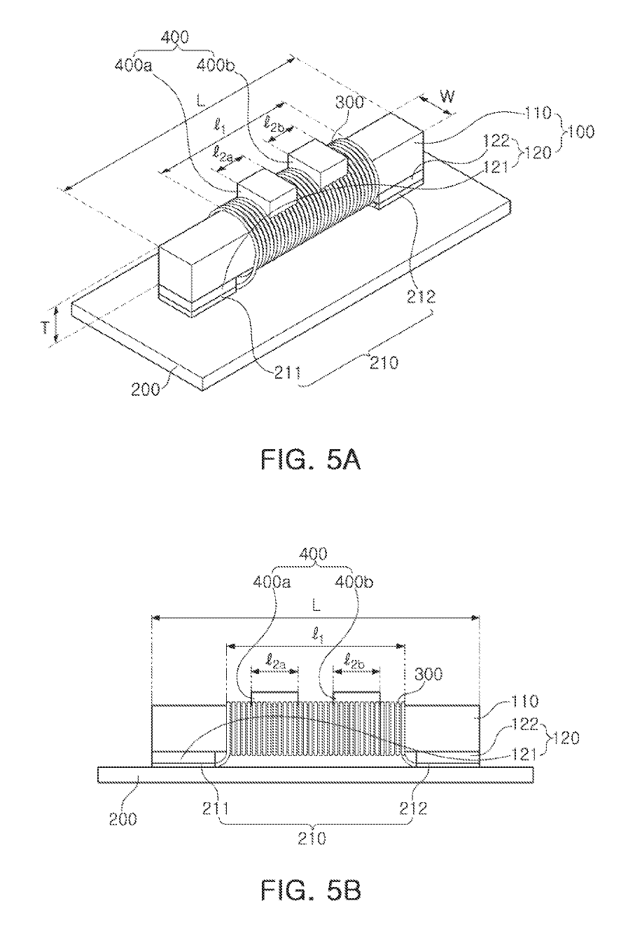

FIGS. 5A and 5B are perspective and side views of a modified embodiment of an antenna structure according to another embodiment. Since the antenna structure illustrated in FIGS. 5A and 5B is similar to the antenna structure in the embodiment described above in relation to FIGS. 4A and 4B, the same or overlapping descriptions will be omitted, and the description below will instead focus on differences between the embodiments.

With reference to FIGS. 5A and 5B, a magnetic block 400 may include first and second magnetic blocks 400a and 400b. The first and second magnetic blocks 400a and 400b may be formed of a magnetic core material and may be disposed to be spaced apart from each other in such a manner that the first and second magnetic blocks 400a and 400b surround a conductive wire in two regions not overlapping each other in a length direction of a coil 300.

With reference to FIGS. 5A and 5B, the first and second magnetic blocks 400a and 400b may be formed on the magnetic core 110 to cover regions corresponding to lengths l2a and l2b corresponding to portions of a total length l1 of the coil 300 (e.g., l2a<l1 and l2b<l1).

With reference to FIGS. 4A and 4B again, in FIGS. 4A and 4B, a magnetic block 400 is formed on a surface of a magnetic core 110. However, one end portion of the magnetic block 400 (e.g., one end portion in the width direction of the magnetic core 100) may be extended around an outer circumferential surface of the magnetic core 100, and thus, the end portion of the magnetic block 400 contacts the other end portion thereof so that the magnetic block 400 may encompass an entirety of the outer circumferential surface of the magnetic core 100. In such an example, the magnetic block 400 may have an O or ring shape, and may be disposed around the coil 300 to cover a circumferential portion of the coil having a length l2.

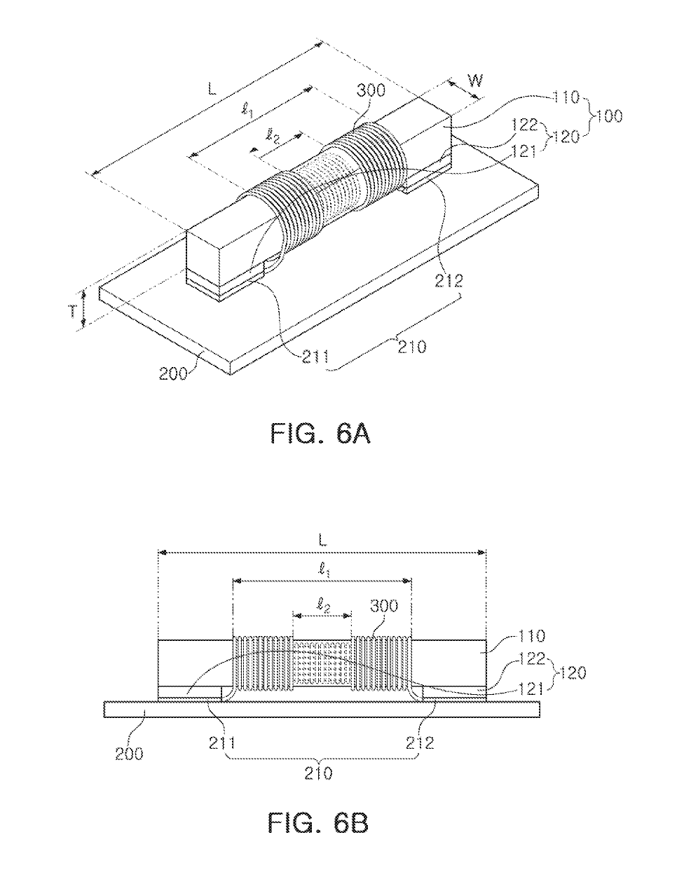

FIGS. 6A and 6B are perspective and side views of an antenna structure according to another embodiment.

Since the antenna structure illustrated in FIGS. 6A and 6B is similar to the antenna structure in the embodiments described above, the same or an overlapping description will be omitted, and the description below will instead focus on differences between the embodiments.

With reference to FIGS. 6A and 6B, the antenna structure may include a core member 100, a circuit board 200, and a coil 300. A conductive wire in a portion of the coil 300 may be embedded in a magnetic core 110.

A structure illustrated in the embodiment may be formed in such a manner that a region in which the coil 300 will be embedded is cut away from the magnetic core 110, the coil 300 is wound around the magnetic core 110, and a material forming the magnetic core 110 is sintered.

The magnetic core 110 in which the conductive wire is embedded has the conductive wire embedded in a portion of the coil 300 in a length direction thereof. The magnetic core 110 with the embedded conductive wire may provide a closed path to a portion of magnetic flux exiting from and entering the magnetic core 110. In a case in which the conductive wire, forming a portion of the coil 300 and embedded in the magnetic core 110, is present, a portion of the magnetic flux formed in the length direction of the magnetic core 110 may not exit from and enter both end surfaces of the magnetic core 110 in the length direction thereof, but may instead follow a path through the magnetic core 110. Specifically, a portion of the magnetic flux formed in the length direction of the magnetic core 110 may follow a path extending through an outer portion of the magnetic core 110 disposed on the outside of the conductive wire embedded in the magnetic core 110.

The conductive wire, forming a portion of the coil 300 in a length direction of the coil 300, may be wound and embedded in the magnetic core 110. With reference to FIGS. 6A and 6B, the conductive wire in the region corresponding to the length l2 may be embedded in the magnetic core, where the length l2 corresponds to a portion of a total length l1 of the coil 300.

In FIGS. 6A and 6B, the coil 100 is illustrated as having only one region in the length direction that is embedded in the magnetic core 110. However, the conductive wire may be embedded in the magnetic core 110 in a plurality of regions in the length direction of the coil 300.

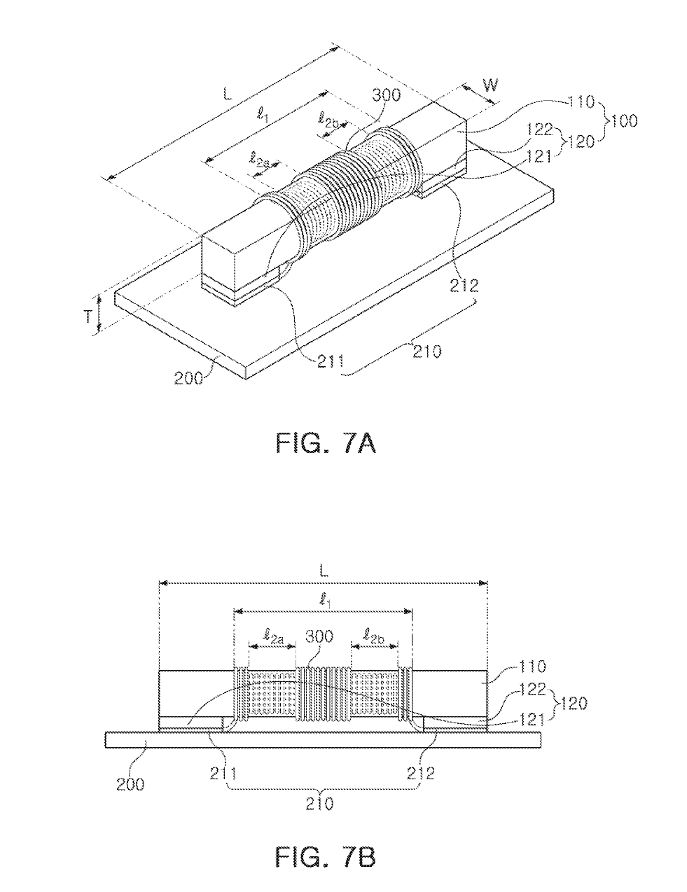

FIGS. 7A and 7B are perspective and side views of a modified embodiment of an antenna structure according to another embodiment.

Since the antenna structure illustrated in FIGS. 7A and 7B is similar to the antenna structures in embodiments described above, the same or an overlapping description will be omitted, and the description below will instead focus on differences between the embodiments.

With reference to FIGS. 7A and 7B, the conductive wire is embedded in the magnetic core 110 in a plurality of regions not overlapping each other in a length direction of the coil 300. In detail, the conductive wire is embedded in the magnetic core 110 in regions corresponding to lengths l2a and l2b, which correspond to distinct non-contacting portions of a total length l1 of the coil 300.

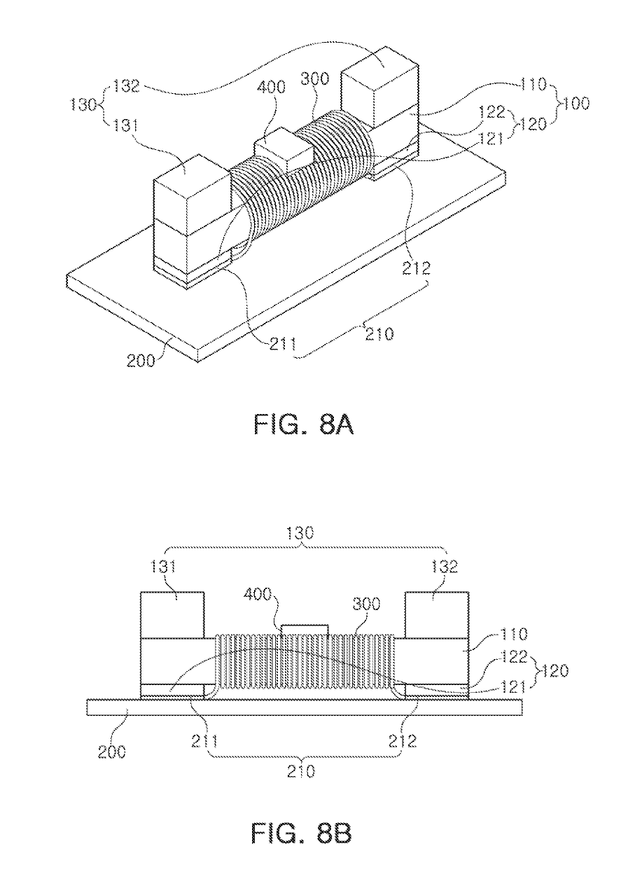

FIGS. 8A and 8B are perspective and side views of an antenna structure according to another embodiment.

With reference to FIGS. 8A and 8B, an antenna structure according to another embodiment may include a core member 100, a circuit board 200, a coil 300, and a magnetic block 400. In addition, the core member 100 may include a magnetic core 110, a support member 120, and a protruding member 130.

Comparing the antenna structure according to the embodiment in FIGS. 8A and 8B with the antenna structure according to the embodiment in FIGS. 4A and 4B, since the antenna structure according to the embodiment shown in FIGS. 8A and 8B further includes the protruding member 130 in the core member 100, hereinafter, a composition of the protruding member 130 will be described in detail.

The protruding member 130 may include first and second protruding members 131 and 132.

The first and second protruding members 131 and 132 may respectively protrude from one end portion and another end portion (e.g., another end portion opposite to the one end portion in the length direction of the magnetic core 110 as shown, or in a different direction intersecting with the length direction thereof such as for example a thickness direction thereof).

Each of the first and second protruding members 131 and 132 may include one end surface through which magnetic flux exits and enters. In addition, the end surface through which the magnetic flux exits and enters may be provided as one end surface in a direction of the first and second protruding members 131 and 132.

For example, with reference to FIGS. 8A and 8B, the magnetic flux may exit from and enter through top surfaces of the first and second protruding members 131 and 132. In a casein which the magnetic flux exits from the top surface of the first protruding member 131, the magnetic flux may enter through the top surface of the second protruding member 132. Conversely, in a case in which the magnetic flux enters through the top surface of the first protruding member 131, the magnetic flux may exit from the top surface of the second protruding member 132.

An external communications device with which short-distance wireless communication is undertaken with an antenna apparatus may be disposed in the protrusion direction of the first and second protruding members 131 and 132 (e.g., a direction aligned with the direction along which the first and second protruding members 131 and 132 are disposed). In addition, according to an embodiment, the magnetic flux may exit from and enter the end surface in the protrusion direction of the first and second protruding members 131 and 132, thereby expanding a radiation range of the magnetic flux.

However, positions of the first and second protruding members 131 and 132 of the protruding member 130 are not limited to the positions shown or described above. In addition, the first and second protruding members 131 and 132 may be formed in various positions, as long as the magnetic flux may exit and enter through the protruding members 131 and 132. Furthermore, the number of protruding members 130 may be changed such that only a single protruding member or three or more protruding members may be used.

According to an embodiment such as that shown in FIGS. 8A and 8B, the composition of the protruding member 130 of the antenna structure may be the same as the composition of the antenna structure according to an embodiment described above, thus expanding the radiation range of the magnetic flux.

As set forth above, according to embodiments described herein, an antenna structure and an antenna apparatus may be configured to have a chip shape (e.g., a substantially cuboid shape), thus being miniaturized. In addition, a value of magnetic flux radiated by the antenna structure and the antenna apparatus may be increased, and a range of the magnetic flux radiation may be expanded, simultaneously.

While illustrative embodiments have been shown and described above, it will be apparent to those skilled in the art that modifications and variations could be made without departing from the scope of the present inventive concepts as defined by the appended claims.

What is claimed is:

1. An antenna apparatus, comprising:
an antenna structure including a magnetic core extended in one direction, a conducive wire wound around the magnetic core to form a coil, and a magnetic material surrounding the conductive wire in a portion of the coil; and
an integrated circuit (IC) supplying an electrical current to the coil,
wherein a portion of magnetic flux generated by flow of the electrical current supplied to the coil exits from one end surface of the magnetic core and enters another end surface of the magnetic core opposite to the one end surface in the one direction, and another portion of the magnetic flux flows through the magnetic material surrounding the conductive wire.

2. The antenna apparatus of claim 1, wherein the magnetic material surrounds a plurality of regions of the coil spaced apart from each other in a length direction of the coil.

3. The antenna apparatus of claim 1, wherein the magnetic material is shaped as a block disposed on the magnetic core to surround the conductive wire in the portion of the coil.

4. The antenna apparatus of claim 3, wherein the magnetic material is disposed adjacent to the magnetic core such that the conductive wire in the portion of the coil is embedded between the magnetic core and the magnetic material.

5. An antenna apparatus, comprising:
an antenna structure including a core member, the core member including a magnetic core extended in one direction and a protruding member including first and second protruding members protruding in a different direction intersecting with the one direction from one end portion and another end portion of the magnetic core in the one direction, respectively, the antenna structure further including a conductive wire wound around the magnetic core to form a coil, and a magnetic material surrounding the conductive wire in a portion of the coil; and
an IC supplying an electrical current to the coil,
wherein a portion of magnetic flux generated by flow of the electrical current supplied to the coil exits from a surface of the first protruding member in the different direction to enter a surface of the second protruding member in the different direction, and another portion of the magnetic flux follows a path that is formed entirely through the core member and the magnetic material.

6. The antenna apparatus of claim 5, wherein the magnetic material surrounds a plurality of separate regions of the conductive wire that are spaced apart from each other in a length direction of the coil.

7. The antenna apparatus of claim 5, wherein the magnetic material is shapes as a block disposed on the magnetic core to surround the conductive wire in the portion of the coil.

8. The antenna apparatus of claim 5, wherein the magnetic material is disposed adjacent to the magnetic core such that the conductive wire in the portion of the coil is embedded between the magnetic material and the magnetic core.

9. An antenna structure, comprising:
a magnetic core;
a conductive wire wound around the magnetic core to form a coil; and
a magnetic block disposed on the conductive wire in a portion of the coil in a length direction of the coil such that the portion of the coil is disposed between the magnetic core and the magnetic block.

10. The antenna structure of claim 9, wherein the magnetic block includes the same material as the magnetic core.

11. The antenna structure of claim 9, wherein the magnetic block is disposed on the conductive wire in the portion of the coil in the length direction of the coil such that the conductive wire in the portion of the coil is surrounded on all sides by the magnetic core and the magnetic block.

12. The antenna structure of claim 9, wherein the antenna structure includes a plurality of magnetic blocks including the magnetic block, and each of the plurality of magnetic blocks is disposed on a separate region of the conductive wire spaced apart from the other magnetic blocks in the length direction of the coil.

13. The antenna structure of claim 9, wherein the magnetic block surrounds an outer circumferential surface of the coil.

14. An antenna structure, comprising:
a magnetic core; and
a coil wound around the magnetic core,
wherein a portion of the coil in a length direction of the coil is embedded within the magnetic core.

15. The antenna structure of claim 14, wherein a conductive wire of the portion of the coil in the length direction of the coil is embedded within the magnetic core.

16. The antenna structure of claim 14, wherein a plurality of regions of a conductive wire of the coil that are spaced apart from each other in the length direction of the coil are embedded in the magnetic core.

17. An electronic apparatus comprising:
a case having an outer surface;
an integrated circuit (IC) supplying an electrical current; and
a chip antenna disposed on the outer surface of the case of the electronic apparatus, receiving the electrical current supplied by the IC, and configured for short-distance wireless communications,
wherein the chip antenna includes a magnetic core formed of a magnetic material, a coil wound around the magnetic core such that a portion of the coil is embedded within a protrusion formed of the magnetic material of the magnetic core.

18. The electronic apparatus of claim 17, wherein the chip antenna is disposed nearest a first edge from among outer edges of the outer surface of the case, and the chip antenna is disposed such that a length direction of the magnetic core of the chip antenna intersects with the first edge of the outer surface of the case that is nearest the chip antenna.

19. The electronic apparatus of claim 17, wherein the chip antenna is configured for near field communication (NFC), magnetic secure transmission (MST), wireless power transfer (WPT), or radio frequency identification (RFID).

20. The electronic apparatus of claim 17, wherein the portion of the coil that is embedded within the protrusion is disposed in a central region in the length direction of the magnetic core.

21. The electronic apparatus of claim 17, wherein the portion of the coil that is embedded within the protrusion has a length shorter than a length of the coil measured in the length direction of the magnetic core.

22. An antenna structure, comprising:
a magnetic core;
a coil wound around the magnetic core; and
a magnetic material disposed on a portion of the coil,
wherein the magnetic core forms an open loop path for magnetic flux generated by current flow in the coil, and
wherein the magnetic material forms a closed loop path for magnetic flux generated by current flow in the portion of the coil on which the magnetic material is disposed.

23. The antenna structure of claim 22, wherein the portion of the coil on which the magnetic material is disposed has a length smaller than a length of the coil.

24. The antenna structure of claim 23, wherein the magnetic material is disposed on a central portion of the coil in a length direction of the coil, such that magnetic flux generated by current flow in regions of the coil on both sides of the central portion flows through the open loop path.

25. An electronic apparatus comprising:
a case having an outer surface;
an integrated circuit (IC) supplying an electrical current; and
the antenna structure of claim 22 disposed on the outer surface of the case of the electronic apparatus and receiving the electrical current supplied by the IC.
